(19) United States
(12) Patent Application Publication
(10) Pub. No.: US 2023/0131622 A1
(43) Pub. Date: Apr. 27, 2023

(54) AIR CONDITIONING DEVICE

(71) Applicant: Shenzhen Relicare Medical Co., Ltd., Shenzhen (CN)

(72) Inventors: Wei HE, Shenzhen (CN); Yutai HUANG, Shenzhen (CN); Lifei ZENG, Shenzhen (CN); Tao RAO, Shenzhen (CN); Guoyuan ZHU, Shenzhen (CN)

(73) Assignee: Shenzhen Relicare Medical Co., Ltd., Shenzhen (CN)

(21) Appl. No.: 18/145,322

(22) Filed: Dec. 22, 2022

Related U.S. Application Data
(63) Continuation of application No. PCT/CN2020/102977, filed on Jul. 20, 2020.

(30) Foreign Application Priority Data
Jun. 24, 2020 (CN) 202010589646.3

(51) Int. Cl. F24F 13/20; F24F 11/00; F24F 13/28

(52) U.S. Cl. CPC F24F 13/20; F24F 11/0001; F24F 13/28; F24F 2221/125

(57) ABSTRACT

Disclosed is an air conditioning device, including a telescopic main structure, a ventilation air conditioning assembly and a control assembly, the ventilation air conditioning assembly is installed on the main structure, the main structure is configured to form a hermetic space inside it, and is configured to stretch or fold the hermetic space. The ventilation air conditioning assembly is configured to form a differential pressure environment in the hermetic space, the control assembly can be used to control the main structure to stretch or fold, and control the ventilation air conditioning assembly to adjust an air pressure, a temperature and a humidity in the hermetic space.

### CROSS-REFERENCE TO RELATED APPLICATIONS

This application is a continuation application of International Application No. PCT/CN2020/102977, filed on Jul. 20, 2020, which claims priority to Chinese Patent Application No. 202010589646.3, filed on Jun. 24, 2020. The disclosures of the above-mentioned applications are incorporated herein by reference in their entireties.

### TECHNICAL FIELD

The present disclosure relates to the field of ventilation, in particular to an air conditioning device.

### BACKGROUND

For environments that need to isolate aerosols, dust droplets and other air-suspended substances, devices which can generate a differential pressure environment are used in the prior art to achieve this function. However, the existing devices that generate the differential pressure environment are bulky and have a strict requirement on the use environment, and are not convenient to move or construct on a large scale.

Therefore, an air conditioning device is needed which occupies a small area, and is convenient to use and construct to solve the above problem.

### SUMMARY

In view of this, the purpose of the present disclosure is to provide an air conditioning device that achieves air conditioning through a telescopic main structure and a ventilation air conditioning system. The air conditioning device includes: a telescopic main structure, a ventilation air conditioning assembly and a control assembly, the ventilation air conditioning assembly is installed on the main structure;

the main structure is configured to form a hermetic space inside the main structure, and is configured to stretch or fold the hermetic space;

the ventilation air conditioning assembly is configured to form a differential pressure environment in the hermetic space;

the control assembly is connected to the main structure and/or the ventilation air conditioning assembly, the control assembly is configured to control the main structure to stretch or fold, and/or

the control assembly is configured to control the ventilation air conditioning assembly to adjust an air pressure, a temperature and a humidity in the hermetic space.

In an embodiment, the main structure includes a skeleton, a deformation mechanism, a sealing part and an access mechanism;

the sealing part covers the skeleton, and is configured to form the hermetic space in the main structure;

the deformation mechanism is connected to the skeleton, and is configured to drive the skeleton to stretch or fold; and

the access mechanism is provided on the skeleton, and is configured to enter or exit the hermetic space.

In an embodiment, a joint of a corner of the skeleton is provided with a fixing part, and the fixing part is configured to support and fix the skeleton.

In an embodiment, a bottom of the fixing part is provided with a caster, and the caster is configured to move the air conditioning device.

In an embodiment, the deformation mechanism is provided between at least two sets of the fixing parts.

In an embodiment, the deformation mechanism is a scissor-type telescopic mechanism, one end of the scissor-type telescopic mechanism is connected to one of the fixing parts, and another end of the scissor-type telescopic mechanism is connected to another fixing part, the control assembly is configured to send an instruction to control the scissor-type telescopic mechanism to stretch or fold.

In an embodiment, the ventilation air conditioning assembly includes an inlet fan, a compressor, a heat exchanger, and an exhaust fan;

the inlet fan, the compressor, and the heat exchanger are installed at a corner of the main structure, the exhaust fan is installed on the corner of the main structure opposite to the inlet fan;

the inlet fan and the exhaust fan are configured to form the differential pressure environment in the hermetic space under a coordination of the control assembly;

the compressor is connected to the heat exchanger; and

the inlet fan, the compressor and the heat exchanger allow air to enter the heat exchanger through the inlet fan and enter the hermetic space under the coordination of the control assembly, to adjust the temperature and humidity in the hermetic space.

In an embodiment, a pressure detector is also provided in the hermetic space, the pressure detector is connected to the control assembly, and when a data detected by the pressure detector is different from a set value, the control assembly is configured to send an instruction to coordinate an adjustment of the inlet fan and the exhaust fan.

In an embodiment, a first purification net is provided at an inlet of the inlet fan, a second purification net is provided at an outlet of the exhaust fan, and the first purification net and the second purification net are configured to filter and purify the air.

In an embodiment, the control assembly includes a controller and an operation platform, the controller is provided in the operation platform, and the operation platform is provided in the main structure

The present disclosure has the following beneficial effects.

By arranging the telescopic main structure, the ventilation conditioning assembly and the control assembly, the control assembly controls the main structure to stretch and fold, so that the air conditioning device of the present disclosure has a simple and compact structure, which can not only form a sufficiently large hermetic space when the air conditioning device is stretched, but also can significantly reduce a volume when the air conditioning device is folded, which is convenient for storage and transportation. By arranging the ventilation conditioning assembly, the pressure, the temperature and the humidity in the hermetic space is adjusted, and the air conditioning device is formed which occupies a small area and is convenient to use.

### BRIEF DESCRIPTION OF THE DRAWINGS

In order to illustrate the technical solutions in the embodiments of the present disclosure or in the related art more clearly, the following briefly introduces the accompanying drawings required for the description of the embodiments or the prior art. Obviously, the drawings in the following description are only part of embodiments of the present disclosure. For those of ordinary skill in the art, other drawings can also be obtained according to the structures shown in these drawings without any creative effort.

FIG. 1 is a schematic view of an air conditioning device in a folded state according to an embodiment of the present disclosure.

FIG. 2 is a schematic view of the air conditioning device in a stretched state according to an embodiment of the present disclosure.

FIG. 3 is a front view of the air conditioning device in FIG. 2.

FIG. 4 is a sectional view along A-A in FIG. 3.

FIG. 5 is a top view of the air conditioning device of the present disclosure.

FIG. 6 is a sectional view along B-B in FIG. 5.

FIG. 7 is a side view of the air conditioning device of the present disclosure.

FIG. 8 is a sectional view along C-C in FIG. 7.

### DETAILED DESCRIPTION OF THE EMBODIMENTS

The technical solutions of the embodiments of the present disclosure will be described in more detail below with reference to the accompanying drawings. It is obvious that the embodiments to be described are only some rather than all of the embodiments of the present disclosure. All other embodiments obtained by persons skilled in the art based on the embodiments of the present disclosure without creative efforts shall fall within the scope of the present disclosure.

It should be noted that if there are directional indications, such as up, down, left, right, front, rear, or the like, involved in the embodiments of the present disclosure, the directional indications are only used to explain a certain posture as shown in the accompanying drawings. If the specific posture changes, the directional indication also changes accordingly.

In addition, if there are descriptions related to “first”, “second”, etc. in the embodiments of the present disclosure, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those of ordinary skill in the art. When the combination of technical solutions is contradictory or cannot be realized, it should be considered that the combination of such technical solutions does not exist or fall within the scope of protection claimed in this disclosure.

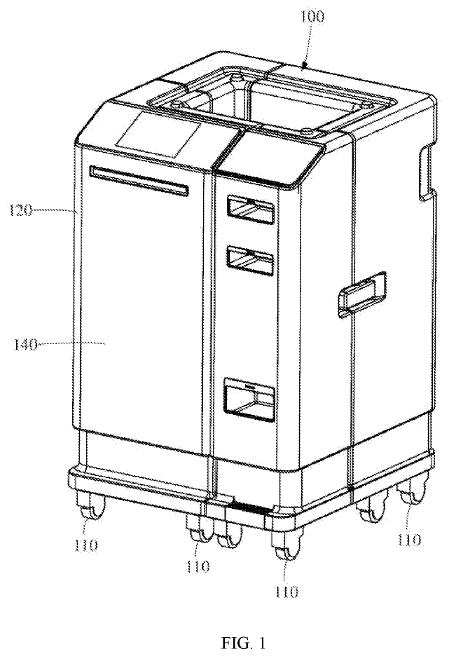

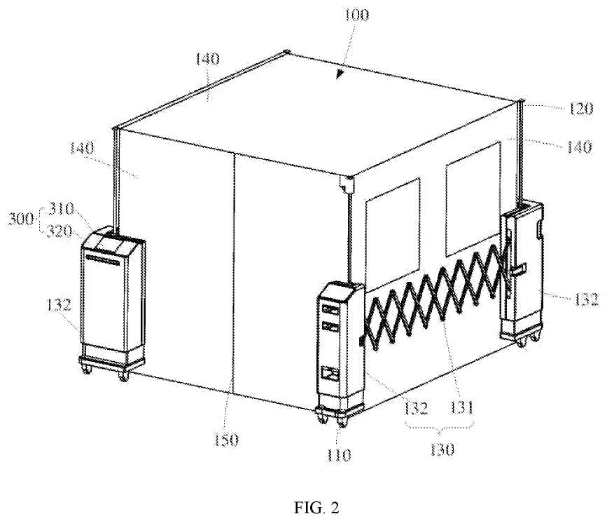

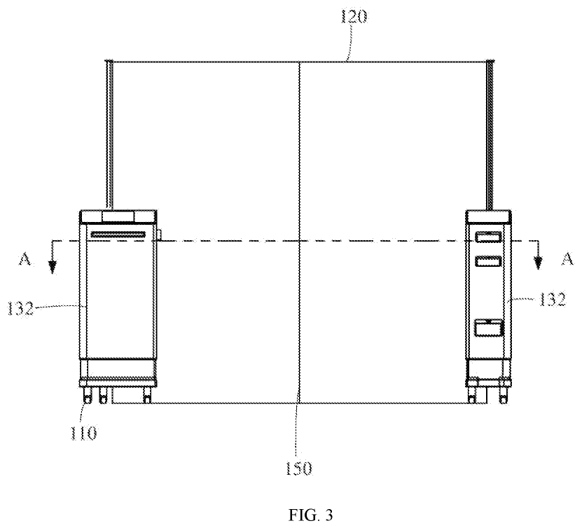

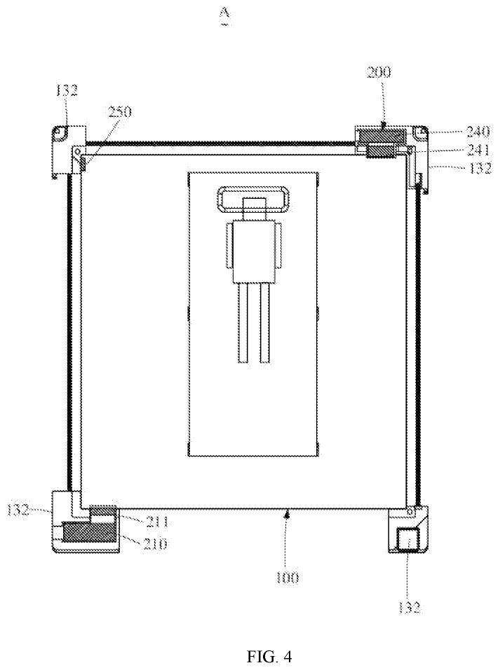

FIG. 1 is a schematic view of an air conditioning device in a folded state according to an embodiment of the present disclosure. FIG. 2 is a schematic view of an air conditioning device in a stretched state according to an embodiment of the present disclosure. FIG. 3 is a front view of the air conditioning device in FIG. 2. FIG. 4 is a sectional view along A-A in FIG. 3. Referring to FIG. 1 to FIG. 4, the air conditioning device includes a main structure 100, a ventilation air conditioning assembly 200 and a control assembly 300. The main structure 100 is configured to form a hermetic space inside the main structure, and can be stretched or folded, so that a volume can be stretched during a period of use, and it can be folded into a compact structure when not in use, which is convenient for storage and transportation. Multiple sets of casters 110 are provided at a bottom of the main structure 100, and a setting of the casters 110 is convenient for an operator to move the air conditioning device to facilitate an installation and operation of the air conditioning device on site. The ventilation air conditioning assembly 200 is configured to form a differential pressure environment in the hermetic space to meet specific usage requirements.

The control assembly 300 is connected to the main structure 100, and the control assembly 300 is configured to control the main structure 100 to stretch or fold. In an embodiment, the control assembly 300 can also be used to control the ventilation air conditioning assembly 200 to adjust an air pressure, a temperature and a humidity in the hermetic space.

The main structure 100 includes a skeleton 120, a deformation mechanism 130, a sealing member 140, and an access mechanism 150. The access mechanism 150 is provided on one side of a front view of the air conditioning device. The access mechanism 150 can be a magnetic curtain, or an interchannel type structure. The sealing component 140 covers the skeleton 120 to form the hermetic space in the main structure 100, and the hermetic space is used by the operator according to a setting requirement. The deformation mechanism 130 is connected to the skeleton 120, and is configured to drive the skeleton 120 to stretch to unfold the air conditioning device into a use state, or the deformation mechanism 130 is folded and shrunk into a small-volume structure, which is convenient for storage and transportation. The deformation mechanism 130 is a scissor-type telescopic mechanism 131, and the air conditioning device can have a good directivity and movement reliability under a driving action of the deformation mechanism 130 when unfolded. One end of the scissor-type telescopic mechanism 131 is connected to a fixing part 132, and one end of the scissor-type telescopic mechanism 131 is connected to another fixing part 132. The control assembly 160 can send an instruction to control the scissor-type telescopic mechanism 131 to stretch or fold, so that the air conditioning device is stretched or folded to meet a need of use. In an embodiment, the fixing part 132 is provided at a joint of a corner of the main structure 100 for supporting the main structure 100.

In an embodiment, the telescopic mechanism 131 is provided between at least two sets of fixing parts, so as to make a movement of the air conditioning device more smooth and stable during stretching or folding.

In an embodiment, the ventilation air conditioning assembly 200 includes an inlet fan 210, a compressor 220, a heat exchanger 230, and an exhaust fan 240. The inlet fan 210, the compressor 220, and the heat exchanger 230 are installed at corners of the main structure 100, and the exhaust fan 240 is installed at the corner of the main structure 100 opposite to the inlet fan 210, so that an air can be fully diffused in the hermetic space inside the air conditioning device and then discharged from a position of the exhaust fan 240. The inlet fan 210 and the exhaust fan 240 can form the differential pressure environment in an inner hermetic space of the air conditioning device under a coordinated action of the control assembly 300. Specifically, according to that an air supply volume is equal to a return air volume and an exhaust air volume and a positive pressure infiltration, an air intake volume of the inlet fan 210 and an exhaust air volume of the exhaust fan 240 are adjusted by the control assembly 300, thereby adjusting the air pressure of the hermetic space in the air conditioning device. In an embodiment, a first purification net 211 is provided at the inlet of the inlet fan 210, a second purification net 241 is provided at the outlet of the exhaust fan 240, and both the first purification net 211 and the second purification net 241 are used to filter the air to ensure a pure ventilation input into the hermetic space and the air output from the air conditioning device. Further, the compressor 220 is connected to the heat exchanger 230, the inlet fan 210, the compressor 220 and the heat exchanger 230 allow air to enter the heat exchanger 230 through the inlet fan 210 and enter the hermetic space under the coordination of the control assembly 300, to heat or cool the air in the heat exchanger 230, and adjust the temperature and the humidity of the hermetic space in the air conditioning device.

In an embodiment, a pressure detector 250 is also provided in the hermetic space of the air conditioning device, and the pressure detector 250 is connected to the control assembly 300. When a data detected by the pressure detector 250 is different from a set value, the control assembly 300 sends instructions to coordinate the inlet fan 210 and the exhaust fan 240 to a pressure adjustment, thereby further ensuring a reliability of the differential pressure environment in the hermetic space of the air conditioning device.

The control assembly 300 includes a controller 310 and an operation platform 320, the controller 310 is provided in the operation platform 320, and the operation platform 320 is provided on the main structure 100. Through a convenient operation of the operator on the operation platform 320, a rapid adjustment of the differential pressure environment and the temperature and the humidity of the hermetic space in the air conditioning device can be realized.

Moreover, in a specific application scenario, seats or beds are set in the hermetic space of the air conditioning device to form an isolation room which is easy to move and store, and can adjust the temperature, the humidity and a differential pressure state.

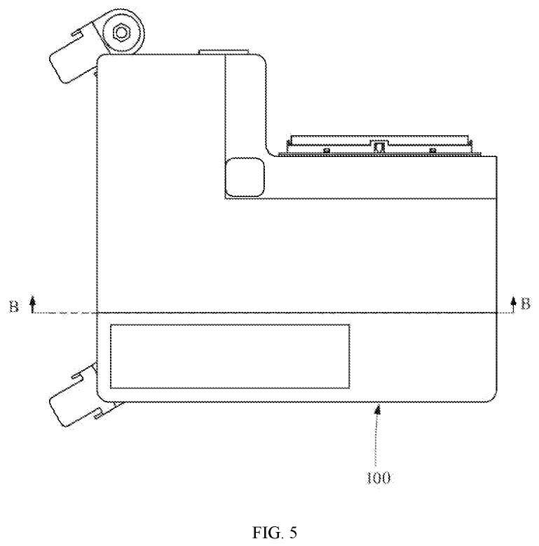

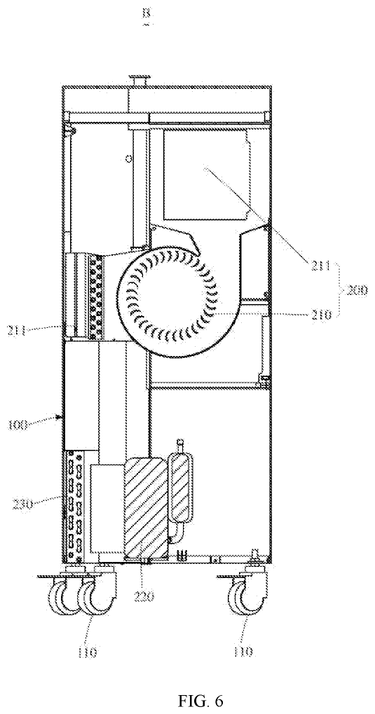

FIG. 5 is a top view of an air conditioning device of the present disclosure. FIG. 6 is a sectional view along B-B in FIG. 5. Referring to FIG. 5 and FIG. 6, the bottom of the air conditioning device is the caster 110, the compressor 220 and the heat exchanger 230 are provided on an upper part of the caster 110, the inlet fan 210 is provided on an upper part of the air conditioning device, the first purification net 211 is provided at the outlet of the inlet fan 210, and an evaporator and the first purification net 211 are provided at the air inlet of the inlet fan 210 to ensure a cleanliness of the air entering the air conditioning device.

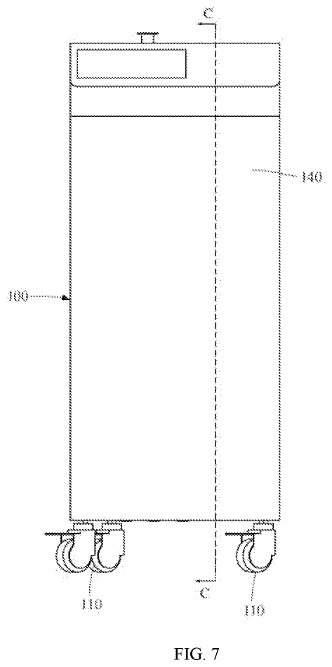

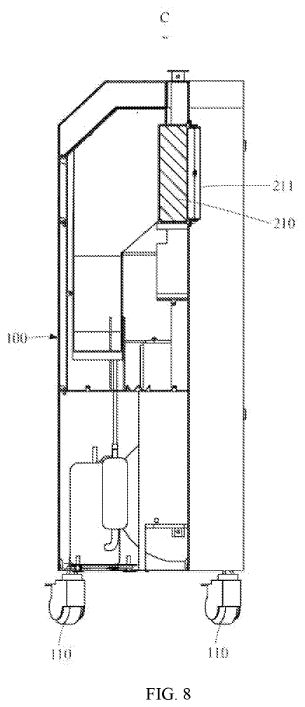

FIG. 7 is a side view of the air conditioning device of the present disclosure. FIG. 8 is a sectional view along C-C in FIG. 7. Referring to FIG. 7 and FIG. 8, the inlet fan is provided at the top of the conditioning device, the first purification net is provided at the outlet of the inlet fan 210, and the first purification net is configured to purify and filter the ventilation to ensure that a clean air is provided in the air conditioning device.

The various technical features of the embodiments can be combined arbitrarily. In order to make the description concise, all possible combinations of the various technical features in the embodiments are not described. However, as long as there is no contradiction in the combination of these technical features, all should be regarded as the scope described in this specification.

The embodiments are only part of the embodiments of the present disclosure, the description of which is specific and detailed, but should not be regarded as limiting the scope of the present disclosure. It should be noted that those skilled in the art can make several modifications and improvements without departing from the concept of the present application, and these all belong to the scope of the present disclosure. Therefore, the scope of the present disclosure should be based on the appended claims.

What is claimed is:

1. An air conditioning device, comprising a telescopic main structure, a ventilation air conditioning assembly and a control assembly, wherein the ventilation air conditioning assembly is installed on the main structure;
the main structure is configured to form a hermetic space inside the main structure, and is configured to stretch or fold the hermetic space;
the ventilation air conditioning assembly is configured to form a differential pressure environment in the hermetic space;
the control assembly is connected to the main structure and/or the ventilation air conditioning assembly, the control assembly is configured to control the main structure to stretch or fold, and/or
the control assembly is configured to control the ventilation air conditioning assembly to adjust an air pressure, a temperature and a humidity in the hermetic space.

2. The air conditioning device according to claim 1, wherein:
the main structure comprises a skeleton, a deformation mechanism, a sealing part and an access mechanism;
the sealing part covers the skeleton, and is configured to form the hermetic space in the main structure;
the deformation mechanism is connected to the skeleton, and is configured to drive the skeleton to stretch or fold; and
the access mechanism is provided on the skeleton, and is configured to enter or exit the hermetic space.

3. The air conditioning device according to claim 2, wherein a joint of a corner of the skeleton is provided with a fixing part, and the fixing part is configured to support and fix the skeleton.

4. The air conditioning device according to claim 3, wherein a bottom of the fixing part is provided with a caster, and the caster is configured to move the air conditioning device.

5. The air conditioning device according to claim 3, wherein the deformation mechanism is provided between at least two sets of the fixing parts.

6. The air conditioning device according to claim 3, wherein the deformation mechanism is a scissor-type telescopic mechanism, one end of the scissor-type telescopic mechanism is connected to one of the fixing parts, and another end of the scissor-type telescopic mechanism is connected to another fixing part, the control assembly is configured to send an instruction to control the scissor-type telescopic mechanism to stretch or fold.

7. The air conditioning device according to claim 1, wherein:
the ventilation air conditioning assembly comprises an inlet fan, a compressor, a heat exchanger, and an exhaust fan;
the inlet fan, the compressor, and the heat exchanger are installed at a corner of the main structure, the exhaust fan is installed on the corner of the main structure opposite to the inlet fan;
the inlet fan and the exhaust fan are configured to form the differential pressure environment in the hermetic space under a coordination of the control assembly;
the compressor is connected to the heat exchanger; and
the inlet fan, the compressor and the heat exchanger allow air to enter the heat exchanger through the inlet fan and enter the hermetic space under the coordination of the control assembly, to adjust the temperature and humidity in the hermetic space.

8. The air cleaning device according to claim 7, wherein a pressure detector is also provided in the hermetic space, the pressure detector is connected to the control assembly, and when a data detected by the pressure detector is different from a set value, the control assembly is configured to send an instruction to coordinate an adjustment of the inlet fan and the exhaust fan.

9. The air conditioning device according to claim 7, wherein a first purification net is provided at an inlet of the inlet fan, a second purification net is provided at an outlet of the exhaust fan, and the first purification net and the second purification net are configured to filter and purify the air.

10. The air conditioning device according to claim 1, wherein the control assembly comprises a controller and an operation platform, the controller is provided in the operation platform, and the operation platform is provided in the main structure.
